(19) United States
(12) Patent Application Publication
(10) Pub. No.: US 2026/0073749 A1
(43) Pub. Date: Mar. 12, 2026

(54) Two-Phase Biometric Access Control System (TBACS)

(71) Applicant: P4 X Group, Inc., Miami, FL (US)

(72) Inventors: Robert William Kocher, Miami, FL (US); Douglas Earl Dyer, Herndon, VA (US); John Shelly Bowling, Reston, VA (US)

(73) Assignee: P4 X Group, Inc., Miami, FL (US)

(21) Appl. No.: 19/386,220

(22) Filed: Nov. 11, 2025

Related U.S. Application Data
(63) Continuation of application No. 18/533,657, filed on Dec. 8, 2023, now Pat. No. 12,475,752.
Application No. 18/533,657 is a continuation-in-part of application No. 17/238,580, filed on Apr. 23, 2021, now Pat. No. 11,874,909.

(51) Int. Cl. G07C 9/26; G06V 20/62; G07C 9/27

(52) U.S. Cl. CPC G07C 9/26; G06V 20/625; G07C 9/27

(57) ABSTRACT

Current biometric access control systems rely on a biometric sensor at the access control point, a design which has shortcomings on throughput or biometric image quality, which is a particularly important limitation for vehicle traffic, particularly when vehicles do not stop. We disclose a Two-Phase Biometric Access Control System (TBACS) that includes biometric, multi-factor authentication in which the biometric sensor is not required to be at the access control point, the access authorization decision is made prior to arriving, and the access confirmation is verified at the access control point using a unique, observable signature that identifies the person seeking access. The access request may be made manually or may be automated.

### CROSS REFERENCE TO RELATED APPLICATIONS

This present application is a continuation-in-part of U.S. application Ser. No. 17/238,580 filed Apr. 23, 2021, the entire contents of which are hereby incorporated by reference.

### FEDERALLY SPONSORED RESEARCH

None.

### BACKGROUND

### Field of the Invention

The invention relates to a Two-Phase Biometric Access Control System (TBACS) that includes biometric, multi-factor authentication in which the biometric sensor is not required to be at the access control point, the access authorization decision is made prior to arriving, and the access confirmation is verified at the access control point using a unique, observable signature that identifies the person seeking access.

### Description of the Related Art

For access control systems that use multiple authentication factors including a biometric, the current state of the art requires a biometric sensor at the point of access. Normally, this either results in a delay at the point of access to give the biometric sensor enough time to get a good image, or, alternatively, the biometric sensor might work quickly but at the cost of reduced or unreliable image quality. Thus, current systems either suffer from poor throughput or increased probability of false negatives and false positives, inconveniencing authorized persons and compromising security, respectively. Furthermore, with current vehicle access control systems, a person's information is collected, and the access authorization decision is made at a single time and place: when the person arrives at the access control point. For security guards making access authorization decisions, working this way seems difficult and particularly stressful when traffic backs up, putting pressure on security guards to make good decisions quickly. The situation can also be stressful to persons desiring entry through the access control point because they worry that they may be denied entry because of some problem that they don't yet know about and may not have time to react to. Furthermore, external events can impact the guard's authorization decisions, and in retrospect, some previous authorizations decisions might have been inappropriate or might have been made differently had there been more time.

To improve throughput of vehicles, ideally the access control system would not require the vehicles to stop but doing that implies a poor biometric image quality or an unreliable biometric image from a biometric sensor at the access control point, false negatives and false positives, and thus inconvenience and reduced security, respectively.

When the biometric sensor is located at the access control point, the sequence of persons passing through must be tightly controlled. If there is any distance between the biometric sensor and other equipment that is used to identify a person, people cannot get out of order or their information can become mixed up with information of another person. That means people have to line up and stay in their line. If in vehicles, each person must stay in their lane. This reduces any efficiency that might otherwise be gained though more flexible use of resources in a shorter line or shorter lane.

Finally, current access control systems that make decisions at the access control point require distribution of all of the information necessary to make those decisions, including information about authentication factors and entry criteria. Maintaining the consistency of this information at many different locations is technically difficult, inefficient, and costly. If a biometric is included in the authentication factors and a biometric match is performed at the location's access control point, then there is the added cost of distributing the biometric matching algorithm and the processing power to run it at all the access control points.

Accordingly, there is a need to overcome the above-identified problems existing in the current state of the art.

### SUMMARY OF THE EMBODIMENTS

TBACS is a two-phased method for secure access control as well as a system supporting this two-phased method. In the first phase, which occurs prior to arriving at the access control point and may be any distance from it, a person desiring access uses the system to securely provide multiple authentication factors including a biometric in an access request for a particular location. A system server receives the request, authenticates the person based on a preexisting database, and checks to see if the person has the authority for access based on fixed criteria provided by the location. If there are any problems with authentication or authorization, the server denies the access request, in some embodiments sending a problem message back to the person.

Otherwise, the server sends a confirmation message authorizing the person's access to both the person and t a computer at the location's access control point. The confirmation message includes an observable signature which is unique to the person. An observable signature is defined visually, such as a person's appearance or vehicle, or an electronic signal such as detection of a personal device such as a mobile phone or RFID. In some embodiments, the unique, observable signature associated with the person seeking access is the unique appearance of the person's vehicle such as the license plate or other observable signature. In some embodiments, the person seeking access is recognized by the unique signature associated with the person's personal device such as a mobile phone or as a special message transmitted by the personal device. In some embodiments, unique signature is a biometric observed by a biometric sensor at the access point but, if so, the biometric is only used to recognize the person seeking access, not to authenticate them, and thus the biometric sensor can be less accurate, especially if used along with additional, independent infom1ation that, when combined, is sufficient for reliable recognition.

This completes the first phase, and most of the work is done. In the second phase, the person arrives at the access control point, presenting a unique signature that is observed by a signature recognition device to identify the person to the computer at the location's access control point. The computer uses the person's recognized unique, observable signature to check to see if it has received an associated access confirmation. If so, the computer activates automated access control equipment, enabling the person to pass through the access control point. Otherwise, the person is denied access and must seek assistance from a security guard. To ensure that no unauthorized person can enter, undetected, without a confim1ation, TBACS recognizes a person's unique signature, limits the confirmation, or tracks the confirmation. In an embodiment, the confirmation is valid only during a limited time window which an unauthorized person might not know. In another embodiment, the location computer checks for attempted multiple uses of a confirmation to detect that an unauthorized person is attempting to enter or has entered.

### BRIEF DESCRIPTION OF THE SEVERAL VIEWS OF THE DRAWINGS

FIG. 1 depicts system components and data flow in TBACS, Phase 1 and Phase 2.

FIG. 2 depicts system components and data flow in TBACS, Phase 1.

FIG. 3 depicts system components and data flow in TBACS, Phase 2.

FIG. 4 illustrates the TBACS steps, Phase 1.

FIG. 5 illustrates the TBACS steps, Phase 2.

FIG. 6 is similar to FIG. 2 but illustrates an embodiment in which authentication is based on a portion of the unique, observable signature and the access request is made automatically as that portion is detected by an authentication computer connected to a signature recognition device prior to arrival at the location.

### REFERENCE NUMERALS

Item 100 is a personal device that includes an interactive display and text input, secure communications capability, and a biometric sensor.

Item 101 is a unique signature that, when observed, may be used to identify a person.

Item 102 is a vehicle that is not part of TBACS but sets context for TBACS in some embodiments; TBACS may be used by a person either in a vehicle or on foot.

Item 103 is an event that is not part of TBACS but might prompt a person to request access in some embodiments or, in other embodiments, might automatically initiate an access request on behalf of the person.

Item 104 is an access request for a location sent securely from personal device 100; the access request contains the location, the person's identity number, and multiple authentication factors, including a biometric, for the person.

Item 105 is a network-connected server with a biometric matching algorithm and a preexisting database of authentication information necessa1y to verify the identity of a person as well as the person's unique signature and criteria, previously set by said location, for determining whether or not said person has the authority to enter a location.

Item 106 is the preexisting database of authentication information necessary to verify the identity of a person as well as the person's unique signature and criteria, previously set by said location, for determining whether or not said person has the authority to enter a location; although drawn separately, it is part of the server 105.

Item 107 is a response message sent by server 105 to personal device 100 in response to access request 104; if the server verifies that the person sending the access request is authorized access, then the response message is an access confirmation, else it is a message describing the reason why the person is not receiving an access confirmation.

Item 108 is the access confirmation 107 and the unique signature associated with the person which is forwarded from server 105 to computer 109 if response message 107 is an access confirmation.

Item 109 is a computer at the location's access control point.

Item 110 is a database that is a part of computer 109 and which stores the access confirmation and associated unique signature for an authorized person who has requested access.

Item 111 is access control equipment, controlled by computer 109, that can physically permit or deny access to a person seeking entry through the location's access control point.

Item 112 is a signature recognition device, connected to computer 109, that is able to read a person's unique signature and provide it to computer 109 when the person is in close proximity.

### DETAILED DESCRIPTION OF THE EXEMPLARY EMBODIMENTS

An advantage of one or more aspects of TBACS is that, by doing most of the work in the first phase, there is very little to do at the access control point, so throughput can potentially increase. If problems occur, they may be solved before arriving at the access control point. This reduces workload on security guards and lowers their stress level. Moreover, a person seeking access knows in advance if they are authorized access, reducing the person's stress level too. Furthermore, security is potentially improved because security guards know, in advance, that the person plans access. If an external security-related event occurs that affects the location or the person's access, security guards have more time to react appropriately.

Another advantage of one or more aspects of TBACS is that the biometric sensor us used in the first phase and therefore does not need to be at the access control point The practical utility is that the biometric sensor may be tailored for capturing good biometric images without having to do so at the access control point, and this is particularly helpful in embodiments involving vehicle traffic that, for best throughput, pass through the access point securely, on-the-move, without stopping.

Because the unique signature can be used to recognize the person, another advantage of one or more aspects of TBACS, in embodiments involving vehicle traffic, is that it's possible to support secure access on-the-move without requiring a vehicle to stop. This can greatly improve access throughput without reducing security because of false-positives or false-negatives from the biometric sensor.

Another advantage of one or more aspects of TBACS is that the, because two phases are used, the sequence of persons passing through the access control point is independent of the sequence of authorization decisions. In the context of multiple pathways at the access control point, the practical utility is that any pathway works. In contrast, without two phases, the sequence of persons passing through the access control point must be tightly controlled to maintain the association between a person and their access control information.

Another advantage of TBACS is centralizing the access control decisions which means that authentication infom1ation and entry criteria can be maintained at one location rather than many. This is technically easier, more efficient, and cheaper than maintaining the same information at many access control points. Furthermore, the biometric matching algorithm in TBACS is centralized along with the processing power to run it which is also cheaper and technically easier. Using centralized decision-making enables TBACS to attain economy of scale. With TBACS, it is possible to centralize access control decision-making over a very large number of access control points, potentially all of them in a nation or even the world. Each location can still tailor its entry criteria at any time.

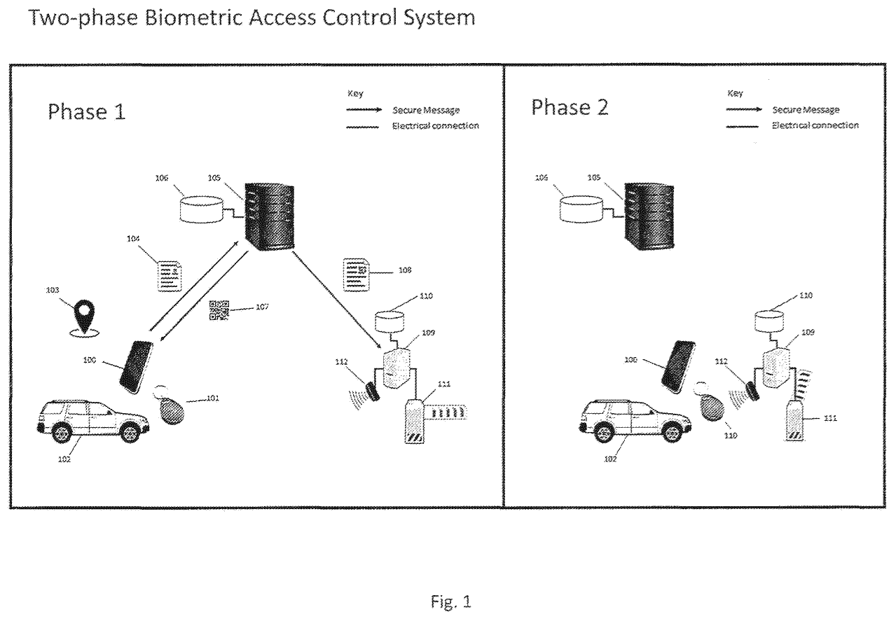

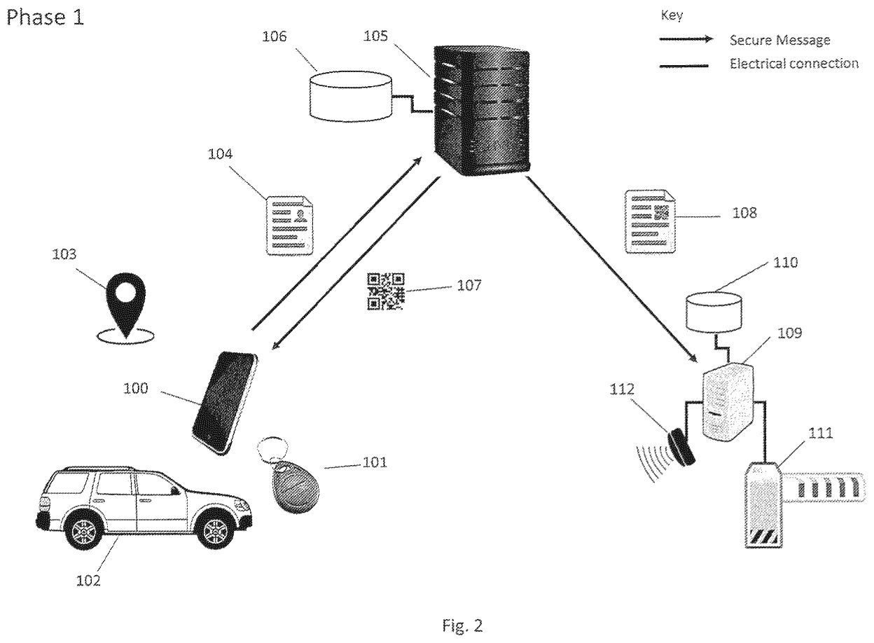

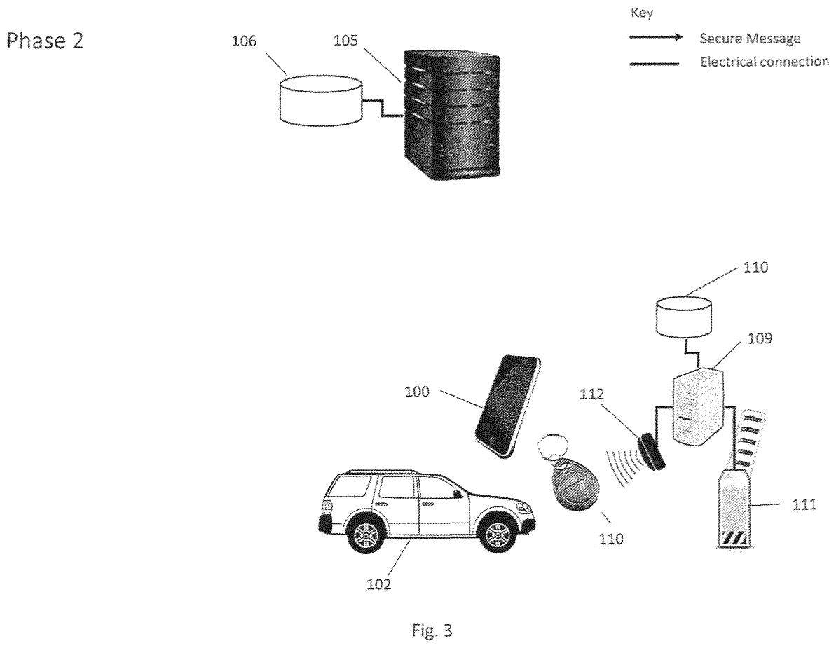

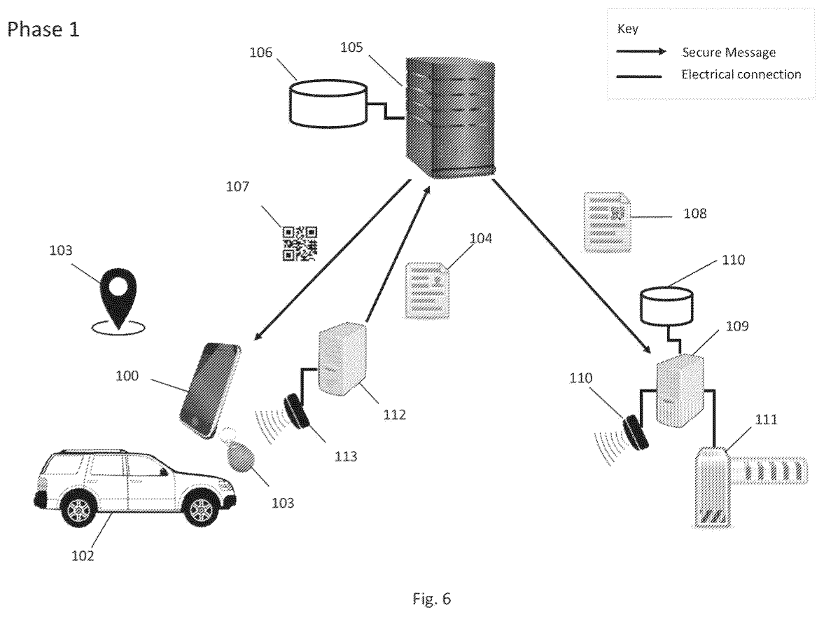

FIG. 1 shows the two phases of TBACS with TBACS equipment, and these two phases are shown larger in FIG. 2 and FIG. 3, respectively, and FIG. 6 shows an automated embodiment for the first phase. Phase 1 occurs before arrival and some distance from the location's access control point. The access control point is typically on the border of the location's area. It is used to control the flow of persons into the location, permitting access to those persons who are authorized while denying access to everyone else.

Turning to FIG. 2, in Phase 1, in an embodiment, some external event 103, not part of TBACS, triggers an access request or motivates a person to initiate an access request. In an embodiment, the person plans to arrive at the location in a vehicle 102, not part of TBACS. In another embodiment, the person plans to travel on foot as a pedestrian. In an embodiment, the person seeking entry to a location requests access using personal device 100 by providing authentication factors that will be used to verify the person's identity by server 105. In an embodiment, the person enters a secret personal identification number (PIN) or password as one authentication factor. In an embodiment, the personal device also has a secret code which is another authentication factor, or, in another embodiment, the secret code is used to create another authentication factor using an algorithm based on the current time. The personal device also captures a biometric image of the person as an authentication factor. In an embodiment, the biometric is a face photo. The person also has a unique, observable signature 101 that can identify the person. In an embodiment, the unique signature is not used as an authentication factor in Phase 1.

In FIG. 2, when all authentication factors have been provided, the personal device 100 sends them, along with the location and person's identity mm1ber, to server 105 in the form of a secure access request message 104. In an embodiment, the person initiates sending the access request 104 using personal device 100. In another embodiment, personal device 100 sends the access request 104 automatically as soon as all authentication factors are provided. The server has a biometric matching algorithm and includes a preexisting database 106 that has information necessary to verify the person's identity using all authentication factors. In an embodiment, the server checks to see if the person's PIN or password match, tests the personal device code, and compares the biometric image with an authoritative biometric image of the person. In an embodiment, the biometric image is a face photo, and the biometric matching algorithm is a facial recog11ition algorithm. If the server 100 finds information for the person's identity number in its database 106 and if all authentication factors match, then the server has verified the person as being, in fact, who they claim to be, that is the person associated with the identity number in the access request 104, and authentication is complete. Otherwise, the server cannot identify the person.

In FIG. 2, if the server 105 has verified the person's identity, then server 105 retrieves from preexisting database 106 the entry criteria previously established by the location. In an embodiment, the criteria are in the fom1 of an access control list of persons allowed to enter. In another embodiment, the criteria are a set of business rules that relate to the information in the preexisting database 106 about the person. If the identified person meets the entry criteria, then they are authorized to enter. Otherwise, the identified person cannot enter.

In FIG. 2, if the person could not be identified or if they do not meet the entry criteria, then, the server 105 securely responds to the access request 104 with a message denying the access request and, in some embodiments, describing the problem.

In FIG. 2 if the identified person meets the entry criteria, server 105 securely responds to the access request 104 with a secure message including an access confirmation 107. The access confirmation I 07 includes a unique secret that indicates that the person should be permitted access. In an embodiment, the confirmation 107 also includes a limited time window during which access is allowed. Next, server 105 securely forwards the access confirmation 107 and the identified person's unique signature in a message 108 to a computer 109 at the location's access control point. Computer 109 then saves the access confim1ation in a database 110 included in computer 109. This completes the first phase of TBACS.

FIG. 3 describes the second phase of TBACS. The vehicle 102, which is not part of TBACS, and also the personal device 100 and unique signature 101 are all shown in close proximity to computer 109 and its connected signature recognition device 112 and access control equipment 111. This is intended to indicate that the person has arrived at the access control point. In FIG. 2, the server 105 and the server's database 106 are also shown. However, there is no secure message sent during this phase, and the server 105 plays no role during the second phase. The server 105 and server's database 106 are included in FIG. 3 simply to help the reader relate FIG. 3 to FIG. 2. Also, in an embodiment, the personal device 100 plays no role in the second phase. In another embodiment, the person still has the personal device 100 and can use it to display the access confirmation in case of any c01mnunication or equipment problem that has prevented the computer 109 from having the person's access confirmation in its internal database, 110.

In FIG. 3, the person has arrived at the location's access control point, presenting their unique, observable signature, 101. The signature recognition device 112 quickly and reliably reads the unique signature 101 to enable computer 109 to retrieve the person's access confirmation 107 based on previous receipt and storage of message 108 from included database 110. In an embodiment, if the person's access confim1ation can be retrieved, then the person should be permitted entry, else denied entry. In another embodiment, the person's access confirmation 107 includes a limited time window, and therefore if the computer can similarly retrieve the access confirmation 107 and the current time is within the time window, then the person should be permitted entry, else denied entry. If the person should be permitted entry, then the computer 109 sends a control signal to automated access control equipment 111 to pem1it physical entry, else computer 109 sends no such signal, and in that case, access control equipment 111 will not permit physical entry. This completes the second phase of TBACS.

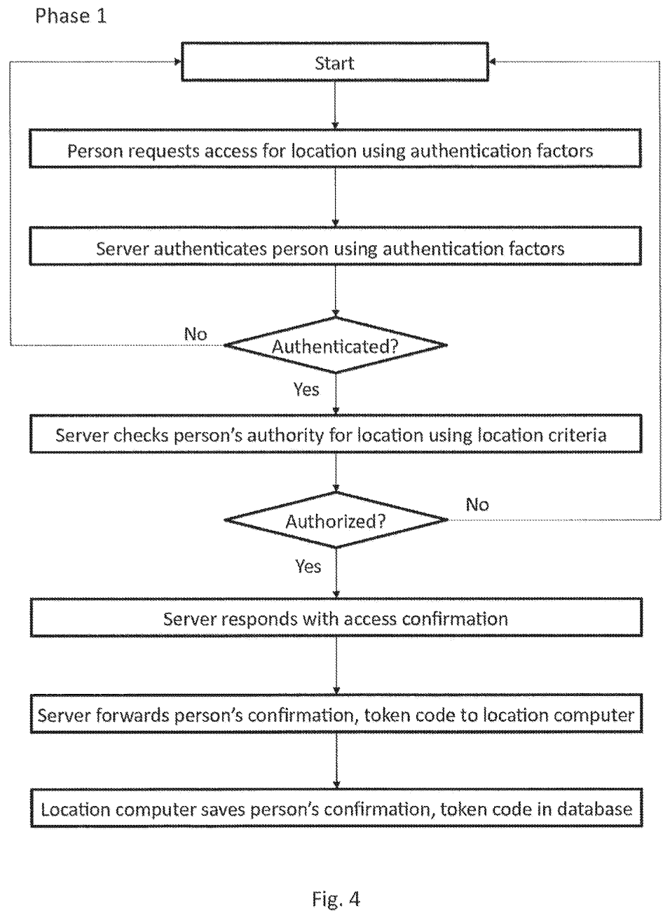

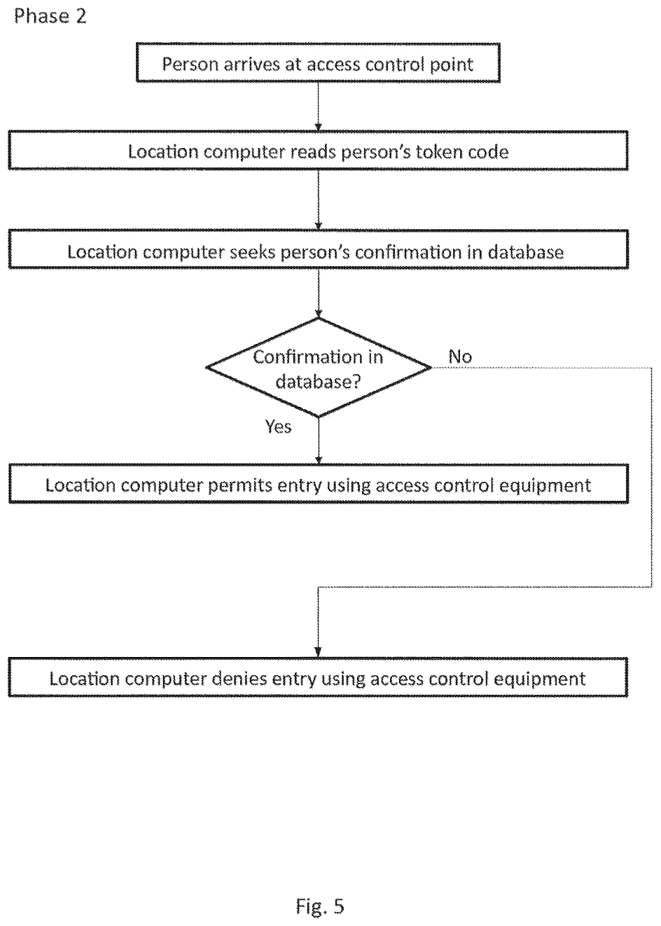

FIG. 4 is a flowchart showing the steps and decisions made in the first phase of TBACS. This flowchart provides a different view of concepts covered in FIG. 2 with less emphasis on system components. Similarly, FIG. 5 is a flowchart showing the steps and decisions made in the second phase of TBACS. FIG. 5 presents a different view of concepts covered in FIG. 3.

In FIG. 4, the first phase of TBACS is started by the person seeking access, in an embodiment, and the person requests access to a location by providing an identity number and authentication factors. In another embodiment, the access request is automatically made in response to an external event. Based on the access request, the server attempts to authenticate (verify the identity of) the person using the authentication factors in the access request and a preexisting database that includes authentication information for the person. If the server cannot verify the identity of the person, it denies the access request, in some embodiments responding with a message describing the problem, and then the person can correct information and start again, if desired. Otherwise, the server checks the authenticated person's authority to enter the location using criteria previously set in the preexisting database. If the authenticated person does not meet the location's criteria for entry, then the server denies the access request, in some embodiments responding with a message describing the problem, and then the person can correct information and start again, if desired. Otherwise, the server responds with an access confirmation which assures the person that they will be permitted to enter through the location's access control point. The server also forwards to the computer at the location's access control point the access confirmation as well as the person's unique signah1re which has been saved in the preexisting database. The computer stores both the access confirmation and its associated unique signature in its own database, facilitating easy retrieval of the access confirmation with the unique signature. This completes phase 1 of TBACS.

In FIG. 5, the second phase of TBACS starts when the person arrives at the access control point. This event is detected by the location computer because the person's unique signature is automatically recognized. The location computer tries to retrieve the person's access confirmation from its database using the unique signah1re. If the access confim1ation is found, then the location computer permits the person to physically enter using automated control equipment, else the location computer denies entry using the automated control equipment.

FIG. 6 shows an embodiment of the first phase of TBACS wherein the access request is automated using some portion of the unique, observable signature that includes enough infom1ation to effectively authenticate the person seeking access. An authentication computer 112 connected to a signature recognition device 113 obse1ves the portion of the unique, observable signah1re used for authentication. In an embodiment, the authentication computer and its signah1re recognition device are located near enough to the desired location so that the location may be inferred, and upon recognizing the person, automatically sends an access request 104 to the server 105. If the part of the unique, observable signature used for authentication is sufficient to identify someone with authority to access, then, similarly to other embodiments, the server 105 replies with a confirmation 104 and forwards the confirmation 108 to the location computer 109, else the server 105 denies access.

Although several exemplary embodiments have been disclosed, they should not be construed to be limiting of the invention in any way, as other alternative embodiments would be readily understood by one of ordinary skill in the art. The invention is defined by the appended claims.

1-10. (canceled)

11. A system for controlling user access of an access control point of a location, the system comprising:
a personal communication device
comprising
an input device configured to receive a user personal identification number (PIN),
a device code, and
a biometric capture device configured to capture user biometric data, the personal communication device further configured to
assemble a location specific access request comprising the user PIN, the device code and the user biometric data, and
transmit the location specific access request to a remote authentication server;
the remote authentication server configured to
receive the location specific access request from the personal communication device,
process the user PIN and the device code to determine any matching user authentication information from stored authentication information,
process, with a biometric matching algorithm, the user biometric data to determine any matching user biometric authentication information from the stored authentication information,
determine whether the location specific access request complies with at least one entry criterion of entry criteria,
one of confirm or deny the location specific access request based on
the any matching user authentication information,
the any matching user biometric authentication information, and
compliance with the at least one entry criterion, and
transmit one of an access confirmation message or an access denial message based on the one of confirming or denying the location specific access request; and
an access control point sub-system comprising an access control point computer configured to receive and store one of the access confirmation message or the access denial message from the remote authentication server,
a unique signature detection device configured to read, at the access control point, and communicate, to the access control point computer, a unique user signature configured to enable the access control point computer to retrieve any corresponding stored access confirmation message or access denial message previous transmitted by the remote authentication server, and
access control point access equipment in communication with the access control point computer configured to one of enable or disable user access at the access control point of the location based on one of the access confirmation message or the access denial message.

12. The system of claim 11, wherein the unique user signature is a license plate and the unique signature detection device is a license plate reader.

13. The system of claim 11 wherein the unique user signature is an electronic signal of the personal communication device and the unique signature detection device is an electronic signal reception device configured to receive the electronic signal from the personal communication device.

14. The system of claim 11 wherein the unique user signature is a message sent from an application on the personal communication device and the unique signature detection device is the access control point computer at the access control point.

15. The system of claim 11 wherein the unique user signature includes a plurality of unique user signatures which are unique to the user.

16. The system of claim 11, wherein the user biometric data includes at least one of face, fingerprint, iris, or voice biometric data.

17. The system of claim 16, wherein the biometric capture device includes at least one of an image capture device and an audio capture device.

18. A system for controlling user access of an access control point of a location, the system comprising:
a personal communication device
comprising
an input device configured to receive a user personal identification number (PIN),
a device code, and a biometric capture device configured to capture user biometric data,
the personal communication device further configured to
assemble a location specific access request comprising the user PIN, the device code and the user biometric data, and
transmit the location specific access request to a remote authentication server;
the remote authentication server configured to
receive the location specific access request from the personal communication device,
process the user PIN and the device code to determine any matching user authentication information from stored authentication information,
process, with a biometric matching algorithm, the user biometric data to determine any matching user biometric authentication information from the stored authentication information,
determine whether the location specific access request complies with at least one entry criterion of entry criteria,
one of confirm or deny the location specific access request based on
the any matching user authentication information,
the any matching user biometric authentication information, and
compliance with the at least one entry criterion, and
transmit one of an access confirmation message or an access denial message based on the one of confirming or denying the location specific access request; and
an access control point sub-system comprising an access control point computer configured to receive and store one of the access confirmation message or the access denial message from the remote authentication server,
a unique signature detection device configured to read, at the access control point, and communicate, to the access control point computer, a unique user signature configured to enable the access control point computer to retrieve any corresponding stored access confirmation message or access denial message previous transmitted by the remote authentication server, wherein the unique user signature includes data comprising at least one of a user appearance image, a vehicle image, a vehicle license plate image, an electronic signal from the personal communication device, and an RFID signal, and
access control point access equipment in communication with the access control point computer configured to one of enable or disable user access at the access control point of the location based on one of the access confirmation message or the access denial message.

19. The system of claim 18, whereby the access control point computer receives the unique user signature from the remote authentication server in one of the access confirmation message or the access denial message before the unique signature detection device reads the unique user signature at the access control point.

20. A method for controlling user access of an access control point of a location, the method comprising:
receiving, via an input device of a personal communication device, a user personal identification number (PIN);
capturing, via a biometric capture device of the personal communication device, user biometric data;
assembling a location specific access request comprising the user PIN, a device code of the personal communication device, and the user biometric data;
transmitting the location specific access request to a remote authentication server;
processing, at the remote authentication server, the user PIN and device code to determine any matching user authentication information from stored authentication information;
processing, at the remote authentication server with a biometric matching algorithm, the user biometric data to determine any matching user biometric authentication information from the stored authentication information;
determining whether the location specific access request complies with at least one entry criterion of entry criteria;
one of confirming or denying the location specific access request based on
the any matching user authentication information,
the any matching user biometric authentication information, and
compliance with the at least one entry criterion;
transmitting one of an access confirmation message or an access denial message based the on one of confirming or denying the location specific access request;
receiving and storing, at an access control point computer, one of the access confirmation message or the access denial message from the remote authentication server;
reading, via a unique signature detection device at the access control point, and communicating, to the access control point computer, a unique user signature configured to enable the access control point computer to retrieve any corresponding stored access confirmation message or access denial message previous transmitted by the remote authentication server; and
communicating with access control point access equipment to one of enable or disable user access at the access control point of the location based on one of the access confirmation message or the access denial message.
